(19) United States
(12) Patent Application Publication
(10) Pub. No.: US 2013/0050374 A1
(43) Pub. Date: Feb. 28, 2013

(54) RECORDING APPARATUS WITH STOPPER DEVICE

(71) Applicant: Kenichi HIRATA, Nagoya-shi (JP)

(72) Inventor: Kenichi HIRATA, Nagoya-shi (JP)

(73) Assignee: BROTHER KOGYO KABUSHIKI KAISHA, Nagoya-shi (JP)

(21) Appl. No.: 13/430,997

(22) Filed: Mar. 27, 2012

(30) Foreign Application Priority Data
Aug. 31, 2011 (JP) 2011-189051

(51) Int. Cl. B41J 2/215

(52) U.S. Cl. 347/104

(57) ABSTRACT

A recording apparatus includes a recorder, a conveyer, a holder, a stopper, an urging member, a light source, and a light controller. The recorder records an image on a recording medium at a recording position. The conveyer conveys a recording medium through the recording position and outputs the recording medium along an output direction. The holder holds a recording medium output by the conveyer. The stopper is disposed downstream of the holder along the output direction and contacts an end of a recording medium when the recording medium is output and the stopper is in a first position. The stopper moves between the first position and a second position, in which an end of the stopper is farther to the holder. The urging member urges the stopper to move to the first position from the second position. The light controller controls the light source to illuminate the stopper.

### CROSS-REFERENCE TO RELATED APPLICATION

This application claims priority to Japanese Patent Application No. 2011-189051, filed Aug. 31, 2011, which is incorporated herein by reference.

### BACKGROUND OF THE INVENTION

1. Field of the Invention

The invention generally relates to recording apparatus with stopper device, which records an image on a recording medium.

2. Description of Related Art

A known recording apparatus includes a recorder, a conveyer, a holder, and a stopper. The recorder records an image on a recording medium. The conveyer conveys the recording medium through a recording position where the recorder records the image on the recording medium. The conveyer then outputs the recording medium with the image recorded thereon in an output direction. The holder holds the recording medium output by the conveyer. The stopper is disposed downstream of the holder in the output direction and is positioned to contact a downstream end of the recording medium in the output direction.

### SUMMARY OF THE INVENTION

When the conveyer outputs forcefully recording media, the recording media may be ejected out of the holder without contacting the stopper. Therefore, a need has arisen for a recording apparatus that overcomes this shortcoming.

According to an aspect of the invention, a recording apparatus described herein may comprise a recorder, a conveyer, a holder, a stopper, and an urging member. The recorder may be configured to record an image on a recording medium at a recording position. The conveyer may be configured to convey a recording medium through the recording position and to output the recording medium along an output direction. The holder may be configured to hold a recording medium output by the conveyer. The stopper may be disposed downstream of the holder along the output direction. The stopper may be configured to contact an end of a recording medium when the recording medium is output by the conveyer and the stopper is in a first position. The stopper may be configured to move selectively between the first position and a second position, in which an end of the stopper is farther to the holder than when in the first position. The urging member may be configured to urge the stopper to move to the first position from the second position.

According to another aspect of the invention, a recording apparatus described herein may comprise a recorder, a conveyer, a holder, a stopper, a light source, and a light controller. The recorder may be configured to record an image on a recording medium at a recording position. The conveyer may be configured to convey the recording medium through the recording position and to output the recording medium along an output direction. The holder may be configured to hold a recording medium output by the conveyer. The stopper may be disposed downstream of the holder in the output direction. The stopper may be configured to contact an end of a recording medium when the recording medium is output by the conveyer and the stopper is in a first position. The light source may be configured to illuminate the stopper. The light controller may be configured to control the light source.

Other objects, features, and advantages will be apparent to persons of ordinary skill in the art from the following detailed description of embodiments of the invention and the accompanying drawings.

### BRIEF DESCRIPTION OF THE DRAWINGS

For a more complete understanding of the present invention, needs satisfied thereby, and the objects, features, and advantages thereof, reference now is made to the following descriptions taken in connection with the accompanying drawings.

FIG. 1 is an exterior, perspective view of an inkjet printer according to embodiments of the present invention.

FIG. 2 is a schematic, cross-sectional view of the inkjet printer depicted in FIG. 1.

FIG. 3A is a perspective view of a stopper device of the inkjet printer of FIG. 1; FIG. 3B is an exploded, perspective view of the stopper device; and FIG. 3C is a perspective view of the stopper device depicting the stopper in a rotated configuration.

FIGS. 4A, 4B, 4C, and 4D are perspective views of the stopper device of the inkjet printer of FIG. 1 in various configurations during a process of moving the stopper device from a position for receiving DIN-A4 size recording media to a position for receiving legal size recording media; and FIG. 4E is a perspective view of a light-emitting diode (“LED”) substrate with a light source thereon.

FIG. 5 is a block diagram depicting an electrical configuration of the inkjet printer of FIG. 1.

FIG. 6 is an enlarged perspective view substantially similar to FIG. 4E and depicting a sensor configured to output a signal based on a position of a stopper device in an inkjet printer according to certain embodiments of the invention.

FIG. 7 is a block diagram depicting an electrical configuration of the inkjet printer of FIG. 6.

FIGS. 8A and 8B are perspective, top views of a stopper device of an inkjet printer according to particular embodiments in various configurations during a process of sliding the stopper device together with a light source; and FIGS. 8C and 8D are perspective, bottom views of the stopper device depicted in FIGS. 8A and 8B in the respective configurations depicted in FIGS. 8A and 8B.

FIG. 9 is an exterior, perspective view of an inkjet printer according to other embodiments of the invention.

FIG. 10 is a block diagram depicting an electrical configuration of the inkjet printer of FIG. 9.

### DETAILED DESCRIPTION OF EMBODIMENTS OF THE INVENTION

Hereinafter, embodiments of the invention now are described with reference to the accompanying drawings; like reference numerals are used to identify similar elements.

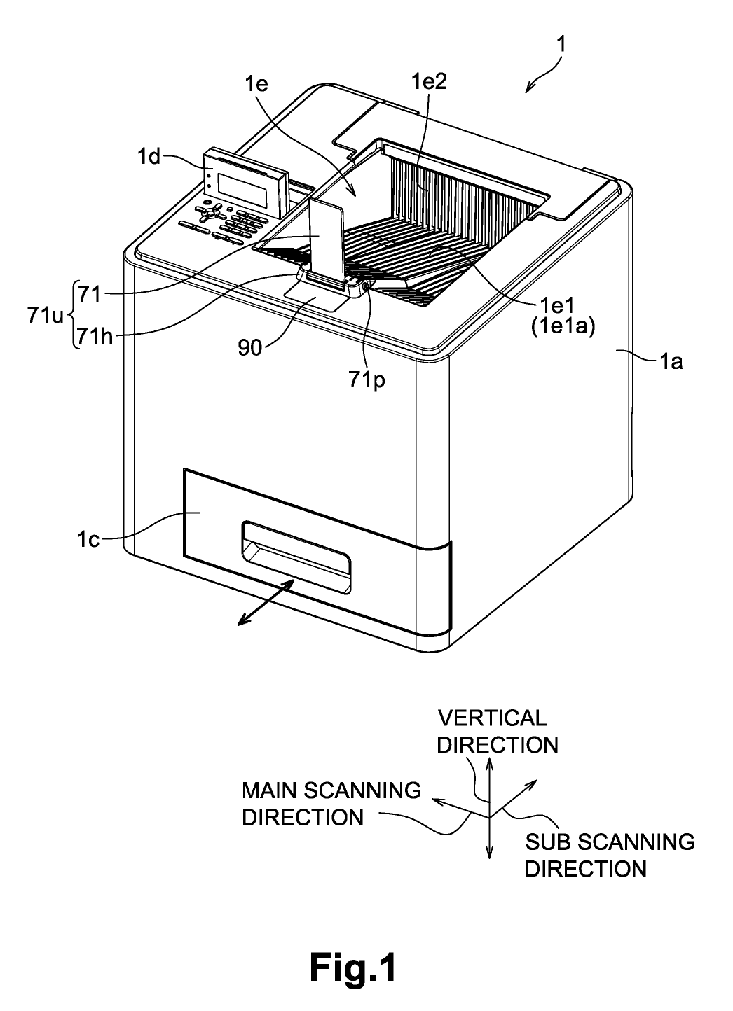

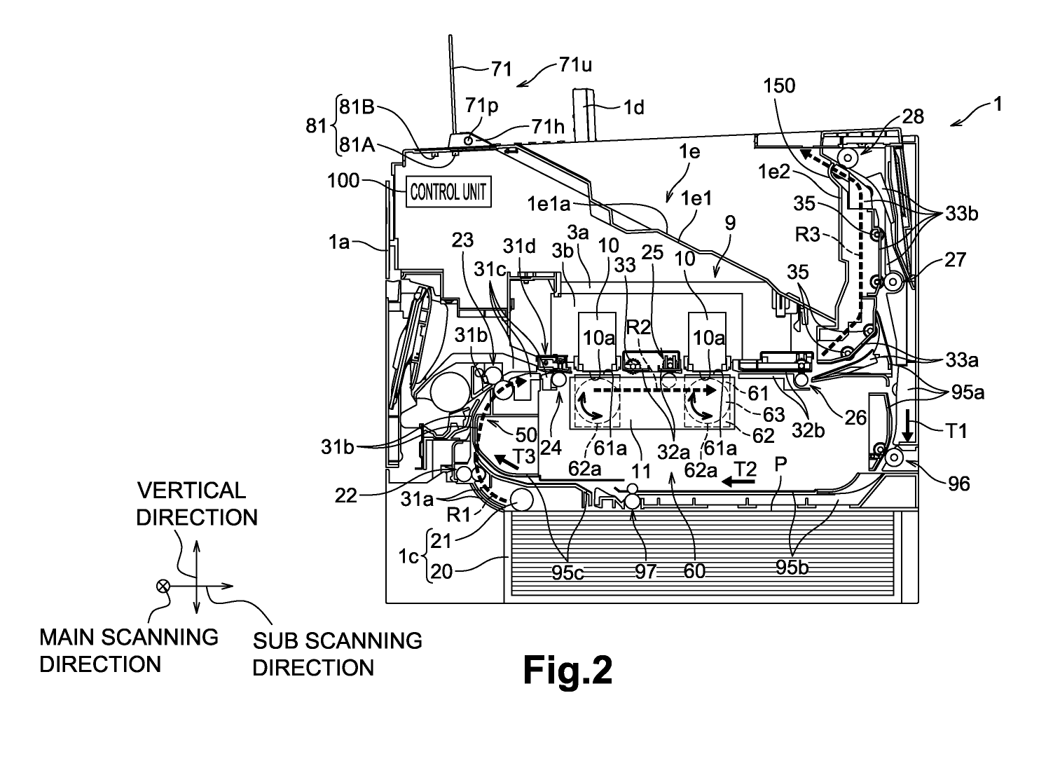

A configuration of an inkjet printer 1 according to embodiments of the present invention now is described, with reference to FIGS. 1 and 2.

The inkjet printer 1 may comprise a rectangular, parallelepiped-shaped housing 1a. An upper portion of the housing 1a may comprise a holding portion 1e and a display 1d. The display 1d may comprise by a liquid crystal display and other components. The holding portion 1e and the display 1d may be exposed to facilitate viewing thereof. An internal space of the inkjet printer 1 may be defined by the housing 1a. As depicted by arrow heads trailed by bold dashed lines in FIG. 2, a conveying path may be formed in the internal space defined by the housing 1a (e.g., the internal space of the inkjet printer 1), along which a paper sheet P may be conveyed in a conveying direction toward the holding portion 1e from the paper feed device 1c.

The internal space of the inkjet printer 1 and components disposed therein now are described with reference to FIG. 2.

The following components may be disposed in the internal space of the inkjet printer 1: a head device 9, which may be provided with two heads 10 configured to eject liquid; two cartridges (not depicted), each of which may correspond to one of the two heads 10; a support portion 60; a paper feed device 1c; a conveyance device 50, which may define the conveying path of the paper sheet P; and a control device 100, which may control components of the inkjet printer 1.

The head device 9 may comprise two heads 10, a main carriage 3a, and a sub-carriage 3b. The main carriage 3a and the sub-carriage 3b may support the heads 10. One of the heads 10 may be a precoating head, which may eject pretreatment liquid, and the other head may be an inkjet head, which may eject black ink. The precoating head may be disposed upstream of the inkjet head along the conveying direction.

The heads 10 may be substantially the same in structure and may be fixed to the sub-carriage 3b. For example, the heads 10 may be substantially rectangular, parallelepiped-shaped, linear heads extending in a main scanning direction, which may be a direction perpendicular to the conveying direction and a vertical direction, as depicted in FIG. 2. The heads 10 may be separated from each other in a sub-scanning direction, which may be a direction perpendicular to the main scanning direction and the vertical direction. The sub-carriage 3b may be supported by the housing 1a via the main carriage 3a.

A plurality of ejection ports may be formed on an ejection surface 10a. The ejection surface 10a may be disposed on a lower surface of the head 10. The head 10 may comprise liquid paths formed therein. The pretreatment liquid and black ink (hereinafter, collectively referred to as “liquid”) supplied from the cartridges may flow in the liquid paths formed in the head 10 and may reach the ejection ports therethrough. For example, the pretreatment liquid may prevent ink bleeding and strike-through and improve color enhancement and dryability of the ink.

The support portion 60 may be disposed to face the ejection surfaces 10a of the heads 10 in the vertical direction. The support portion 60 may comprise: two rotary members 63, each facing one of the heads 10; a platen 61 and a facing member 62 fixed to a peripheral surface of each of the rotary members 63; and a frame 11, which may support rotatably the rotary members 63.

Lengths of the platen 61 and of the facing member 62 along the main scanning direction and the sub-scanning direction may be greater than lengths of the ejection surface 10a along the main scanning direction and the sub-scanning direction. The platen 61 and the facing member 62 may be aligned with the ejection surface 10a along the vertical direction, such that the platen 61 and the facing member 62 may face the ejection surface 10a. A surface of the platen 61 may be a support surface 61a, which may face the ejection surface 10a and may support the paper sheet P while the conveyance device 50 conveys the paper sheet P over the platen 61. A plurality of ribs may be formed in the support surface 61a along the sub-scanning direction. The facing member 62 may comprise a water-impermeable or substantially water-impermeable material. The facing member 62 may comprise a facing surface 62a, which may be smooth and may face the ejection surface 10a.

The rotary member 63 may rotate about an axis of rotation parallel to the main scanning direction. When the rotary member 63 rotates about the axis of rotation, the rotary member 63 may switch between a first configuration (e.g., a configuration depicted in FIG. 2) and a second configuration (not depicted). In the first configuration, the support surface 61a may face the ejection surfaces 10a, but the facing surface 62a may not face the ejection surface 10a. In the second configuration, the support surface 61a may not face the ejection surfaces 10a, but the facing surface 62a may face the ejection surface 10a. The control device 100 may control the rotary member 63 to be in the first configuration when liquid is ejected from the ejection ports against the paper sheet P to form an image thereon and to be in the second configuration when the inkjet printer 1 performs a capping process. Capping is an operation to cause an end of a cap member (not depicted), which may project downward from the peripheral portions of a lower end of each head 10, to abut the facing surface 62a, such that the space facing the ejection surface 10a is separated from the external space.

The paper feed device 1c may be disposed in the lowermost position of the housing 1a, below the head device 9 and the support portion 60. The paper feed device 1c may comprise a paper sheet feed tray 20 and a paper sheet feed roller 21. The paper sheet feed tray 20 may be attachable to and detachable from the housing 1a, along the sub-scanning direction. The paper sheet feed tray 20 is an upwardly-open, box-shaped tray that may hold paper sheets P of several sizes. The control device 100 may control a motor to rotate the paper sheet feed roller 21, and the paper sheet feed roller 21 may send out the uppermost paper sheet P in the paper sheet feed tray 20.

The conveyance device 50 may define a conveying path. The conveying path may comprise paths R1, R2, and R3, which may be associated with conveyance of a paper sheet P from the paper feed device 1c, and paths T1, T2, and T3, which may be associated with re-conveyance of the paper sheet P. The conveyance device 50 may comprise the following components, which may define the paths R1, R2, and R3; the paths T1, T2, and T3; and a conveying motor (not depicted).

The path R1 may be a U-shaped path in a plane perpendicular to the main scanning direction and may extend from the paper feed device 1c to a recording position (e.g., a position facing an ejection surface 10a). The path R1 may be defined by a guide 31a, a pair of rollers 22, a guide 31b, a pair of rollers 23, a guide 31c, a guide 31d, and a pair of rollers 24. These components may be arranged in the above-described order along the conveying direction.

The path R2 may pass through the recording position of each of the heads 10, and the path R2 may be defined by a guide 32a, a pressure roller 33, and a pair of rollers 25. These components may be disposed between the heads 10. The pressure roller 33 and the pair of rollers 25 may be arranged in the above-described order along the conveying direction.

A path R3 may be a U-shaped path in a plane perpendicular to the main scanning direction and disposed further downstream in the conveying direction, than the recording position. The path R3 may extend from a guide 32b to the holding portion 1e. The path R3 may be defined by guides 32b, 33a, and 33b; a pressure roller 35; and pairs of rollers 26, 27, and 28. The pairs of rollers 26, 27, and 28 may be arranged in the above-described order along conveying direction. The pair of rollers 28 may output the paper sheet P from the housing 1a, via the opening 150, in an output direction. For example, the output direction may be a horizontal direction (e.g., perpendicular to the vertical direction depicted in FIG. 2) or the output direction may be inclined with respect to the horizontal direction. Multiple pressure rollers 35 may be disposed along the path R3.

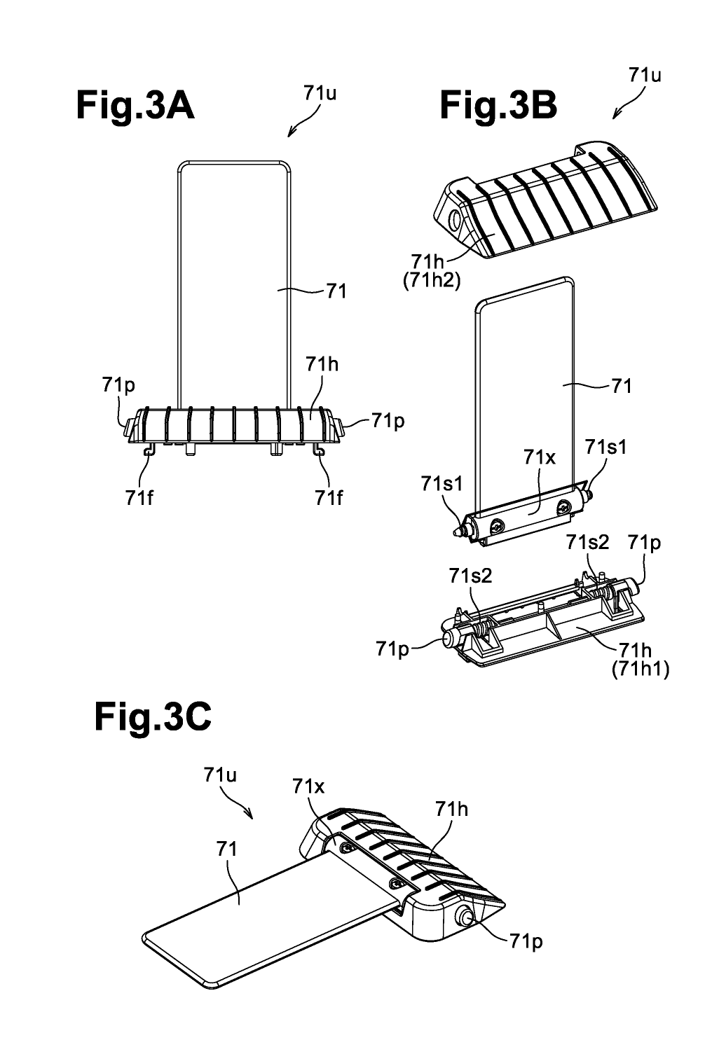

The path R3 may be disposed downstream from the recording position in the conveyance direction and may curve in the direction opposite to the path R1 while extending upward in substantially the vertical direction, as depicted in FIG. 3. Accordingly, based on the orientation of the inkjet printer 1 depicted in FIG. 2, the path R1 may curve to the right (e.g., the path R1 is a U-shaped path which opens to the right), whereas the path R3 may curve to the left (e.g., the path R3 is a U-shaped path which opens to the left). Thus, the paths R1, R2, and R3 may combine to form a conveyance path having an inverse S shape.

The path T1 may extend downward in the substantially vertical direction depicted in FIG. 2. The path T1 may be defined by a guide 95a and a pair of rollers 96. The path T2 may extend in a direction opposite to the sub-scanning direction depicted in FIG. 2, and the path T2 may be defined by a guide 95b and a pair of rollers 97. The path T3 may extend obliquely along the vertical direction depicted in FIG. 2 and may reach the middle of the path R1. The path T3 may be defined by a guide 95c.

The guides 31a, 31b, 31c, 31d, 32a, 32b, 33a, and 33b may comprise guide surfaces for guiding the paper sheet P. Each of the pairs of rollers 22, 23, 24, 25, 26, 27, and 28 and of the pairs of rollers 96 and 97 may comprise a driving roller connected to the conveying motor and a driven roller, which may be driven by the respective driving roller.

A configuration of the holding portion 1e now is described with reference to FIGS. 1 and 2.

The holding portion 1e may comprise a support member 1e1 and a guide member 1e2, as depicted in FIGS. 1 and 2.

The support member 1e1 may be formed by an upper wall of the housing 1a and may comprise a surface 1e1 a (e.g., a support surface) that may support the output paper sheet P. The support surface 1e1 a may incline downward with respect to the horizontal direction in a direction opposite to the output direction (e.g., toward the guide member 1e2).

The guide member 1e2 may extend in the vertical direction and in the main scanning direction, and may be disposed upstream of the support surface 1e1 a along the output direction. An opposite side of the guide member 1e2 (e.g., a side of the guide member 1e2 opposite to the surface of the guide member 1e2 that faces the support member 1e1) may define the path R3, as depicted in FIG. 2. In particular, the opposite side of the guide member 1e2 may form a part of the guides 33a and 33b.

A configuration of a stopper device 71u now is described with reference to FIGS. 3A-C and 4A-E.

The stopper device 71u may comprise a plate-shaped stopper 71 and a holder 71h that may hold the stopper 71. The stopper device 71u may be disposed downstream of the support surface 1e1 a along the output direction. When the stopper 71 is in a standing position, as depicted in FIG. 3A, an upper end of the stopper 71 may be disposed directly above the support member 1e1 and above the display 1d in the vertical direction. For example, the upper end of the stopper 71 or at least a portion thereof may be disposed above all other components of the inkjet printer 1, as depicted in FIG. 2. The pair of rollers 28 may output the paper sheet P, and the stopper 71 may hold the paper sheet P on the support surface 1e1a to reduce instances of the inkjet printer 1 ejecting the paper sheet P out of the support surface 1e1a when the inkjet printer 1 outputs the paper sheet P at particular speeds. Thus, the pair of rollers 28 may output the paper sheet P through an output port 150 near the upper end of the guide member 1e2 and may eject the paper toward the stopper 71. When the stopper 71 is in the standing position, a leading end of the paper sheet P may contact the stopper 71 before landing. The stopper 71 subsequently may direct the paper sheet P to fall into the holding portion 1e with the leading end thereof separated from the stopper 71, such that the support surface 1e1a may support the paper sheet P and the trailing end of the paper sheet P may contact the guide member 1e2. The leading end of the paper sheet P may be an end of the paper sheet P disposed downstream from the trailing end of the paper sheet P along the output direction. The particular speed, at which the pair of rollers 28 may output the paper sheet P through the output port 150, may be a speed at which the inkjet printer 1 may eject the paper sheet P out of the support surface 1e1a, unless the stopper 71 is disposed on the inkjet printer 1 in the standing position.

As depicted in FIGS. 3A-C, the stopper 71 is a substantially rectangular plate member. A length of the stopper 71 in a longitudinal direction of the stopper 71 (e.g., a distance from the holder 71h to the upper end of the stopper 71, as depicted in FIG. 3A) may correspond to the thickness of a plurality of hundreds of paper sheets P (e.g., three hundred sheets). The stopper 71 may be made of resin and may be transparent and flexible. One end of the stopper 71 along the longitudinal direction of the stopper 71 (e.g., an end opposite the upper end of the stopper 71) may comprise a shaft 71x, as depicted in FIG. 3B.

The holder 71h may comprise a base 71h1 and a cap 71h2, as depicted in FIG. 3B. The base 71h1 and the cap 71h2 may combine together with the shaft 71x therebetween to support rotatably the stopper 71. The stopper device 71u may be assembled by fitting the shaft 71x into a recess of the base 71h1 and subsequently attaching the cap 71h2 to the base 71h1.

As depicted in FIG. 3B, urging members 71s1, which may urge the stopper 71 into a standing or upright position, may be disposed at both ends of the shaft 71x. Each of the urging members 71s1 may be a double-torsion spring, which may comprise two coil portions and an arm portion that may connect the two coil portions. Each coil portion may use shaft 71x as guide bar, respectively, and the arm portion may contact stopper 71. Ends of each coil portion may be fixed rotatably to the holder 71h. Therefore, as depicted FIGS. 1, 2, and 3A, the stopper 71 defaults to the standing position, in which the stopper 71 stands upright from the holder 71h (e.g., a first position). When a user applies an external force and presses the stopper 71 against the urging force of the urging members 71s1 with a force greater than a predetermined threshold magnitude, the stopper 71 may rotate about the shaft 71x into a lay down position (e.g., a second position), as depicted in FIG. 3C. When the stopper 71 is n the lay down position, the upper end of the stopper 71 (e.g., the upper end with reference to the standing position, as described above) may be disposed at a position downstream from a lower end of the stopper 71 (e.g., an end of the stopper 71 closest to the holder 71h) along the output direction. By rotating the stopper 71 to the lay down position, a user may conveniently collect paper sheets P supported on the support surface 1e1a. When the user reduces or removes the external force applied the stopper 71, the position of the stopper 71 may return to the standing position from the lay down position. Thus, the stopper 71 may extend longitudinally in substantially the vertical direction in the standing position, and the stopper 71 may extend longitudinally in substantially the horizontal direction in the lay down position.

In configurations of the stopper device 71u that may not comprise an urging member 71s1 therein, the user may leave the stopper 71 in the lay down position, and the inkjet printer 1 may eject the paper sheet P out of the support surface 1e1a unless, for example, the user manually returns the stopper 71 to the standing position before using the inkjet printer. In the configurations described above, the stopper 71 may remain in the standing position unless the stopper 71 is subjected to a force greater than the predetermined threshold. Therefore, the stopper device 71u comprising urging members 71s1 therein may reduce instances of the pair of rollers 28 outputting paper sheets P through an output port 150 and ejecting the paper sheets P out of the support surface 1e1a.

In modified configurations, the stopper 71 may be flexible and may be fixed directly to the base 71h1, without the shaft 71x and the urging members 71s1. When the stopper 71 is subjected to a force greater than another predetermined threshold, the stopper 71 may bend into a lay down position. When the force is removed from the stopper 71, the position of the stopper 71 may return to the standing position from the lay down position.

As depicted in FIG. 3A, a pair of hooks 71f may be disposed on an underside of the base 71h1. As depicted in FIG. 3B, each of the hooks 71f may comprise a projection 71p and an urging member 71s2, which may urge the projection 71p and the hook 71f outward. The urging member 71s2 may be a compression spring, which is disposed in the holder 71h, such that the compression string is compressed to a length less than the free length thereof (e.g., a length when compressive forces and tensile forces are not applied in an axial direction of the spring).

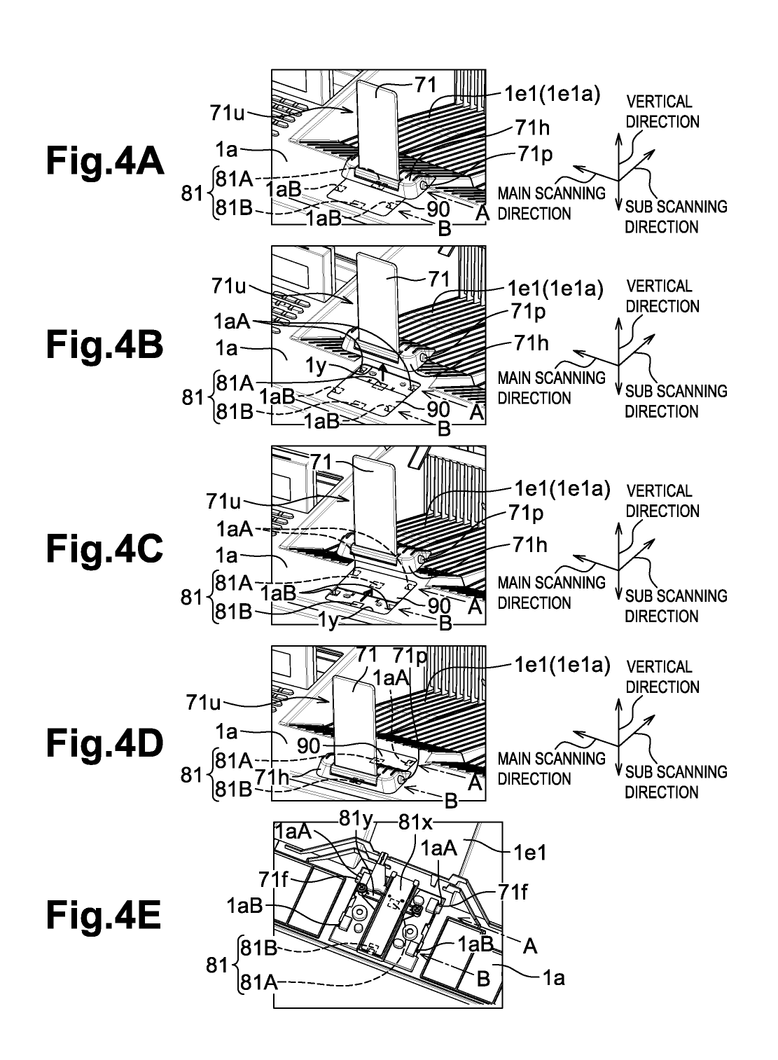

The pair of hooks 71f may be inserted in one of a pair of holes 1aA and a pair of holes 1aB formed in an upper wall of the housing 1a, as depicted FIG. 4E. The stopper device 71u may be fixed to the housing 1a by inserting the pair of hooks 71f in one of the pair of holes 1aA and the pair of holes 1aB and by engaging the hooks 71f with the upper wall of the housing 1a, which may define the holes 1aA and 1aB therein. When the pair of projections 71p is pressed, such that the projections 71p move closer to each other against the urging force of the urging member 71s2, the hooks 71f also may move in a same direction as the projections 71p. Thus the hooks 71f may be removed from the holes 1aA and the holes 1aB, and the stopper device 71u may be removed from the housing 1a.

Configurations of components associated with the stopper device 71u during a process of moving the stopper device 71u from a position A for a DIN-A4 size paper sheet to a position B for a legal size paper sheet now are described with reference to FIGS. 4A, 4B, 4C, 4D, and 4E.

The stopper device 71u may be disposed in alternate positions based on the size of the paper sheet P disposed in the paper feed device 1c. The stopper device 71u may be disposed in the position A for DIN-A4 size, as depicted in FIG. 4A. The stopper device 71u may be disposed in the position B for legal size, as depicted in FIG. 4D. The stopper device 71u may be disposed in the position A when the inkjet printer 1 records on a paper sheet P of DIN-A4 size (210 mm×297 mm). The stopper device 71u may be disposed in the position B when the inkjet printer 1 records on a paper sheet P of legal size (215.9 mm×279.4 mm). When the stopper device 71u is in either of the positions A or B, the distance between the stopper 71 and an end of the support surface 1e1a, which may be an end closest to the guide member 1e2 along the output direction, may be greater than the length of the paper sheet P of the corresponding size (e.g., 297 mm in the DIN-A4 size and 279.4 mm in the legal size) by about 50 mm.

The stopper device 71u may affix to the housing 1a by disposing the holder 71h in a recess 1y formed by an upper surface of the upper wall of housing 1a, as depicted FIGS. 4B and 4C, and engaging the hooks 71f with the upper wall of the housing 1a, which may define the holes 1aA and 1aB therein. The recess 1y may be substantially rectangular in plan view (e.g., in a plane perpendicular to the vertical direction, as depicted in FIGS. 4A-D), may have substantially the same length as the holder 71h along the main scanning direction, and may have a length that is two or three times greater than the length of the holder 71h along the sub-scanning direction. The holder 71h and a cover 90 may be disposed in the recess 1y.

The cover 90 may be a substantially rectangular plate member. The cover 90 may have substantially the same length as the length of the recess 1y in the main scanning direction. The cover 90 may have a length in the sub-scanning direction corresponding to the difference between the length of the holder 71h and the length of the recess 1y along the sub-scanning direction. The cover 90 may slide in the sub-scanning direction (e.g., the output direction of the paper sheet P) when disposed in the recess 1y.

Referring to FIG. 4A, when the stopper device 71u is in the position A, the hooks 71f may be inserted in the holes 1aA, as depicted FIG. 4E. In this configuration, the holes 1aB may be covered by the cover 90. As depicted in FIG. 4B, when the stopper device 71u moves from the position A to the position B, the user may press the projections 71p to remove the hooks 71f from the holes 1aA, and the user may remove the stopper device 71u from the housing 1a. As depicted in FIG. 4C, the cover 90 subsequently may slide to the position A. Thus, the cover 90 may cover the holes 1aA, and the holes 1aB may be exposed. As depicted in FIG. 4D, the holder 71h may be disposed in the previous position of the cover 90. The hooks 71f may be inserted in the holes 1aB, and the stopper device 71u may affix to the housing 1a in the position B.

A light source 81, which may light the stopper 71, now is described with reference to FIGS. 4A, 4B, 4C, 4D, and 4E.

As depicted in FIG. 4E, a light-emitting diode (“LED”) substrate 81x may be attached to an underside of the upper wall of the housing 1a via a frame 81y, such that the LED substrate 81x may face the recess 1y. The LED substrate 81x may comprise a light source 81, which may comprise separate light sources 81A and 81B. Each of the separate light sources 81A and 81B may be a LED. The LED substrate 81x may affix to the frame 81y. The LED substrate 81x may affix to the housing 1a by fixing the frame 81y to the underside of the upper wall of the housing 1a with screws, adhesive, or the like.

The separate light source 81A may be disposed to face the stopper device 71u when the stopper device 71u is in the position A, and the separate light source 81B may be disposed to face the stopper device 71u when the stopper device 71u is in the position B. When the stopper device 71u is in the position A, the separate light source 81A may face the stopper 71, and the separate light source 81B may face the cover 90, rather than the stopper 71, as depicted in FIG. 4A. In particular, when the stopper device 71u is in the position A and in the standing position, the separate light source 81A may be disposed on an extension line of the stopper 71. The extension line may extend in substantially the vertical direction through the stopper 71. Therefore, the separate light source 81A may emit light that may be oriented toward the stopper 71. In this configuration, the cover 90 may cover the separate light source 81B. When the stopper device 71u is in the position B, the separate light source 81B may face the stopper, and the separate light source 81A may face the cover 90, rather than the stopper 71, as depicted in FIG. 4D. In particular, when the stopper device 71u is in the position B and in the standing position, the separate light source 81B may be disposed on the extension line of the stopper 71. Therefore, the separate light source 81B may emit light that may be oriented toward the stopper 71. In this configuration, the cover 90 may cover the separate light source 81A.

Light emitted by the portion of light source 81 that is disposed to face the stopper 71 (e.g., one of the separate light sources 81A and 81B) may illuminate the stopper 71. The manner of lighting the stopper 71 may depend on certain properties of the stopper 71, comprising, for example, light transmittance, surface roughness, haze (e.g., a ratio of luminous diffuse transmittance to total light transmittance), and the like. The stopper 71 may be made of transparent resin. Transparent resin may have light transmittance greater than or equal to 80%; however, when the stopper 71 has a low surface roughness, light may transmit therethrough and only the periphery of the stopper 71 (e.g., the upper end and longitudinal sides) may illuminate. In certain modifications, the surface roughness of the stopper 71 may be increased by texturing (e.g., graining) the surface of the stopper 71. Therefore, light may diffuse on the surface of the stopper 71, and the entire surface of the stopper 71 may illuminate.

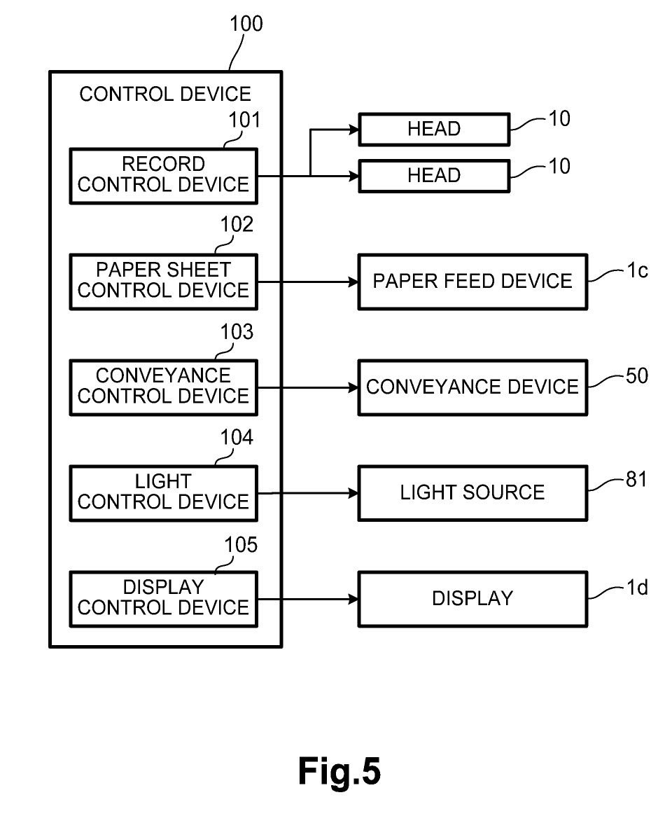

A configuration of the control device 100 and the components of the inkjet printer 1, which the control device 100 controls, now are described with reference to FIG. 5.

The control device 100 may comprise, for example, read only memory (“ROM”), random access memory (“RAM”), an interface (“I/F”), an input/output port (“I/O”), and a central processing unit (“CPU”), which is a processor. The ROM may store therein programs that the CPU may execute, various kinds of fixed data, and other information. Data (e.g., image data) used during the execution of the programs temporarily may be stored in the RAM. In application specific integrated circuits (“ASICs”), rewriting and rearrangement of image data (e.g., signal processing and image processing), as well as other processes, may be performed. The I/F may perform data transmission and reception with external devices (e.g., a PC connected to the inkjet printer 1). The I/O may perform input and output of detection signals detected by various sensors. In the control device 100, software, such as a program stored in the ROM, and hardware, such as the CPU, may cooperate to implement functions of a record control device 101, a paper sheet control device 102, a conveyance control device 103, a light control device 104, a display control device 105, and other devices.

The record control device 101 may control the heads 10 to eject liquid toward the paper sheet P in accordance with image data. The paper sheet control device 102 may control a driving motor of the paper sheet feed roller 21 to output the paper sheet P held in the paper sheet feed tray 20. The conveyance control device 103 may control a conveying motor of the conveyance device 50 to convey the paper sheet P along the conveying path.

The record control device 101, the paper sheet control device 102, and the conveyance control device 103 may control each component in tandem, while synchronizing conveyance of the paper sheet P and ejection of liquid from the heads 10. In particular, the conveyance control device 103 may convey the paper sheet P, which the paper sheet control device 102 may send out from the paper sheet feed tray 20, along the path R1 and then the path R2. When the paper sheet P supported by the support surface 61a passes a position directly below the heads 10 (e.g., a recording position) along the path R2, the control device 101 may drive each head 10. Liquid may eject from ejection ports of the ejection surface 10a onto the paper sheet P, such that the inkjet printer 1 may form an image on the paper sheet P. In a single-sided recording operation, the pair of rollers 28 subsequently may output the paper sheet P to the holding portion 1e. In a double-sided recording operation, the paper sheet P may not be output to the holding portion 1e, but instead, may return for conveyance along the paths T1, T2, and T3. The paper sheet P subsequently may be sent into the middle of the path R1 and may be conveyed along the paths R2 and R3 again. After heads 10 form an image on the reverse side, the pair of rollers 28 may output the paper sheet P to the holding portion 1e.

The light control device 104 may control the light source 81 to emit light in one emission mode, which may be selected from among multiple emission modes, based on a status of the inkjet printer 1. In particular, the light control device 104 may control the light source 81, such that both the separate light sources 81A and 81B may illuminate green when the inkjet printer 1 is in a normal status, which may be associated with, for example, error-free operations; and both the separate light sources 81A and 81B may illuminate orange when the inkjet printer 1 is in an error status, which may be associated with, for example, jamming (e.g., jamming of paper sheet P in the conveying path).

When the stopper device 71u is in the position A, the stopper 71 may illuminate in the same manner as the separate light source 81A (e.g., with a green or orange light source), based on the emission mode of the light source 81. The separate light source 81B may illuminate in the same manner as the separate light source 81A (e.g., with a green or orange light source), based on the emission mode of the light source 81. Because the cover 90 may cover the separate light source 81B in the position A, light emitted by the separate light source 81B may not illuminate the stopper 71 and may not leak out of the recess 1y.

Similarly, when the stopper device 71u is in the position B, the stopper 71 may illuminate in the same manner as the separate light source 81B (e.g., with a green or orange light source), based on the emission mode of the light source 81. The separate light source 81A may illuminate in the same manner as the separate light source 81B (e.g., with a green or orange light source), based on the emission mode of the light source 81. Because the cover 90 may cover the separate light source 81A in the position B, light emitted by the separate light source 81A may not illuminate the stopper 71 and may not leak out of the recess 1y.

The display control device 105 may control the display 1d to display information in a display mode selected from among a plurality of display modes, based on the status of the inkjet printer 1. In particular, the display control device 105 may control the display 1d to display recording state information (e.g., size of the paper sheet P and the number of paper sheet P) before recording. The display control device 105 may control the display 1d to display a preview of an image that the inkjet printer may record when the inkjet printer 1 is in the normal status. The display control device 105 controls the display 1d to display a message indicating an error (e.g., “paper jam; remove paper”) when the inkjet printer 1 is in the error status.

As described above, the stopper 71 in the standing position, as depicted in FIGS. 1 and 2, may illuminate differently, based on the status of the inkjet printer 1. This may facilitate viewing the light and determining the status of the inkjet printer 1. The upper end of the stopper 71 may be disposed above all or many of the other components of the inkjet printer 1. This may facilitate viewing the light from positions around the inkjet printer 1, without interference or with reduced interference.

The stopper device 71u may be disposed in one of the positions A and B along the output direction in accordance with the size of the paper sheet P, as depicted in FIGS. 4A-D. Therefore, paper sheets P of several sizes (e.g., two) may be used in inkjet printer 1. When the stopper device 71u is in the position A, the separate light source 81B may be covered by the cover 90. When the stopper device 71u is in the position B, the separate light source 81A may be covered by the cover 90. Therefore, the light emitted by the covered one of the separate light sources 81B and 81A may not illuminate the stopper 71 and may not leak out of the recess 1y. The light emitted by the one of the separate light sources 81A and 81B, which are disposed underneath the stopper 71 may illuminate the stopper 71. This may reduce confusion associated with the position of the stopper device 71u, in accordance with the position of the stopper device 71u. When the light is emitted by one of the separate light sources 81B and 81A that is not disposed underneath the stopper 71, the stopper device 71u may appear to be in a position different from the actual position of the stopper device 71u. In particular, for example, when the size of paper sheet P is DIN-A4, the stopper device 71u may be disposed in the position A. When the light emitted by the separate light source 81B leaks out, the stopper device 71u may appear to be disposed in the position B, and the position of the stopper device 71u may be checked unnecessarily, which may be inefficient and waste time. Substantially the same problem may arise when the paper sheet P is of legal size, the stopper device is disposed in position B, and the light emitted by the separate light source 81A leaks out. In the configuration described above, however, the light emitted by the separate light source 81B or 81A may not leak out because of the cover 90. Thus, the above-described configuration may reduce instances of incorrectly recognizing the position of the stopper device 71u.

The light source 81 may comprise the separate light sources 81A and 81B, which may be disposed in positions corresponding to the positions A and B. The cover 90 may be slidable in the sub-scanning direction (e.g., the output direction of the paper sheet P) to cover the one of the separate light sources 81A and 81B that is not at a position corresponding to the position of the stopper device 71u. In the above-described configuration, the light emitted by one of the separate light sources 81A and 81B may illuminate the stopper 71 by sliding the cover 90 to another position.

The holding portion 1e may be disposed on the upper surface of the upper wall of the housing 1a, as depicted in FIG. 1. The above-described configuration may facilitate viewing the light exiting the stopper 71 and may facilitate a determination of the state of the inkjet printer 1.

The upper end of the stopper 71 (e.g., the upper end of the stopper 71 in the standing position) may be disposed above the display 1d, as depicted in FIG. 1. The above-described configuration may facilitate viewing the light exiting the stopper 71 and may facilitate a determination of the state of the inkjet printer 1.

The light control device 104 may control the light source 81 in cooperation with the control of the display 1d by the display control device 105. In particular, the display control device 105 may control the display 1d to display a message indicating the error status (e.g., “paper jam; remove”). The light control device 104 may control the light source 81, such that both of the separate light sources 81A and 81B emit orange light. In the configuration described above, the status of the inkjet printer 1 readily may be checked by observing the stopper 71 and the display 1d. The stopper 71 may be in the standing position unless the stopper is forced into the lay down position. Thus, the stopper 71 may be in the standing position when the user is away from the inkjet printer 1 and the light exiting the stopper may notify the user of the status of the inkjet printer 1 from a distance. It may be important for the user to know the error status of the inkjet printer 1, and, thus, the inkjet printer 1 readily may notify the user of the error status by emitting light through the stopper 71 in the standing position.

The stopper 71 may be disposed at the front side (e.g., the front left side of FIG. 1) of the inkjet printer 1. A display surface of the display 1d may be oriented toward the front side of the inkjet printer 1, as depicted in FIG. 1. The inkjet printer 1 may comprise an opening formed at the front side thereof, through which the paper sheet feed tray 20 is attached to the housing 1a. The front side of the inkjet printer 1 may be an upstream side along a direction in which the paper sheet feed tray 20 may be attached to the housing 1a, as depicted by the double-ended arrow in FIG. 1. In the configuration described above, the stopper 71 may be disposed in front of the inkjet printer 1, and the light exiting the stopper 71 may be viewed conveniently and the status of the inkjet printer 1 also may be checed conveniently.

The stopper 71 may be flexible. In the configuration described above, even when excessive force (e.g., impact load by the paper sheet P abutting the stopper 71 and the force applied by the user) is applied to the stopper 71, the force may be absorbed by the flexible stopper 71 and instances of damage to the stopper 71 may be reduced.

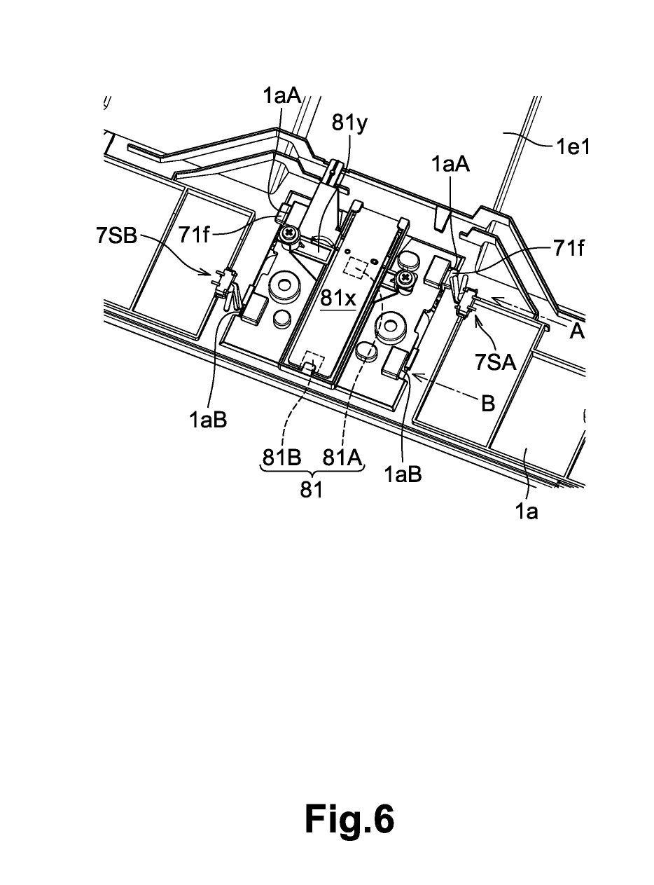

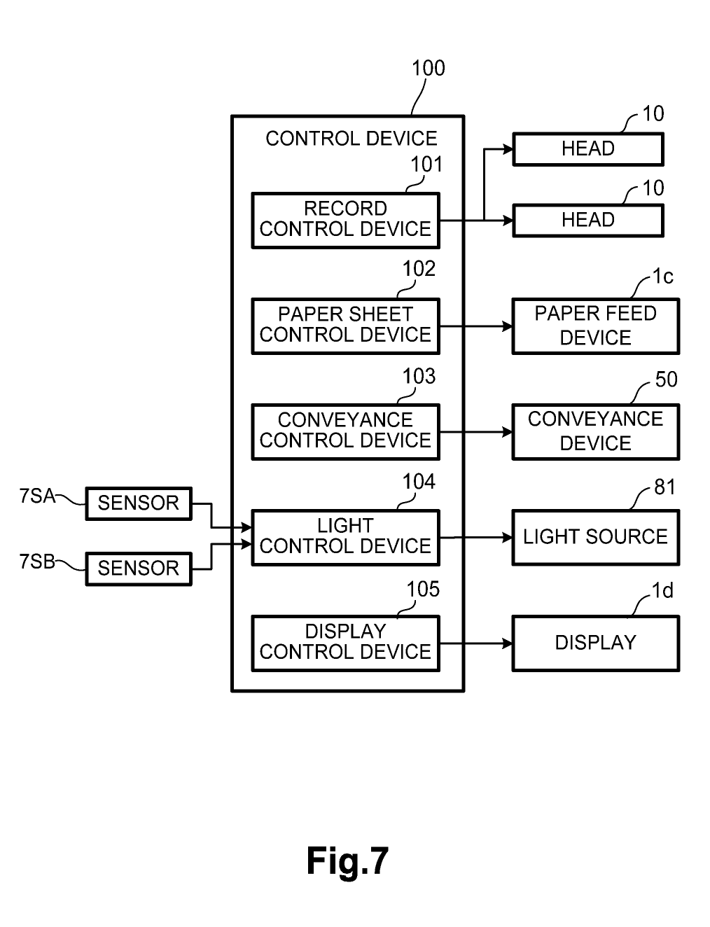

An inkjet printer according to certain embodiments of the invention now is described with reference to FIGS. 6 and 7.

According to FIG. 6, the inkjet printer may have substantially the same configuration as that of the inkjet printer 1, as depicted in FIG. 1, except that the inkjet printer, as depicted in FIG. 6, may comprise sensors 7SA and 7SB, which may output a signal relative to a position of the stopper device 71u, and that the light control device 104 may control the light source 81 in accordance with the signal output by the sensors 7SA and 7SB.

The sensors 7SA and 7SB may be disposed to correspond to the positions A and B, respectively, as depicted in FIG. 6. The sensors 7SA and 7SB may be flat spring sensors and may bend when contacting the hook 71f of the stopper device 71u. The sensors 7SA and 7SB may output an ON signal to the light control device 104 when the flat spring is bent, and the sensors 7SA and 7SB may output an OFF signal to the light control device 104 when the flat spring is not bent.

As depicted in FIG. 6, the sensor 7SA may contact the hook 71f, may bend, and may output an ON signal to the light control device 104 when the stopper device 71u is in the position A. In this configuration, the sensor 7SB may not bend and may output an OFF signal to the light control device 104. The sensor 7SB may contact the hook 71f, may bend, and may output an ON signal to the light control device 104 when the stopper device 71u is in the position B. In this configuration, the sensor 7SA may not bend and may output an OFF signal to the light control device 104.

The light control device 104 may control the light source 81 in accordance with signals received from the sensors 7SA and 7SB. In particular, when the sensor 7SA outputs an ON signal and the sensor 7SB outputs an OFF signal (e.g., when the stopper device 71u is in the position A), light control device 104 may control the light source 81, such that the separate light source 81A may emit light and the separate light source 81B may not emit light. When the sensor 7SA outputs an OFF signal and the sensor 7SB outputs an ON signal (e.g., when the stopper device 71u is in the position B), light control device 104 may control the light source 81, such that the separate light source 81B may emit light, and the separate light source 81A may not emit light.

The embodiments of FIGS. 6 and 7 may reduce energy consumption compared with a configuration in which both the separate light sources 81A and 81B may emit light all of the time.

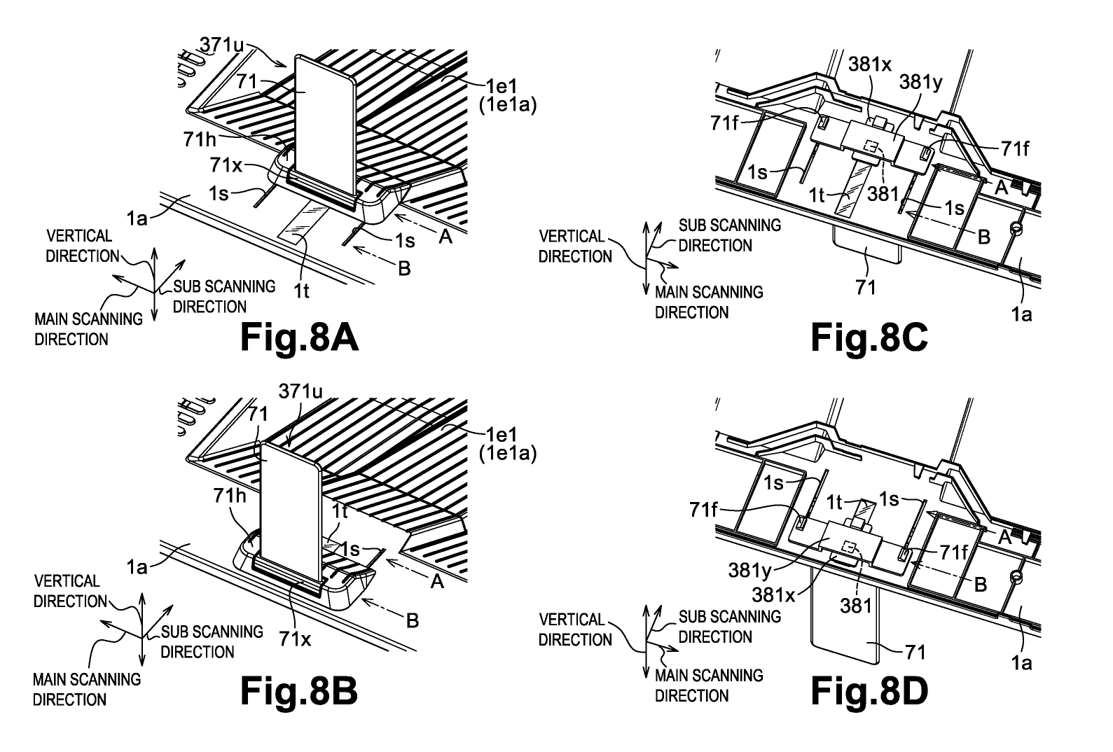

An inkjet printer according to particular embodiments of the invention now is described with reference to FIGS. 8A-D.

The inkjet printer, as depicted in FIGS. 8A-D, may have substantially the same configuration as that of the inkjet printer 1, as depicted in FIG. 1, except that the configuration of the stopper device may be different. In the inkjet printer of FIGS. 8A-D, there may be only one light source, rather than two light sources, and there may be no cover corresponding to cover 90. Unlike the embodiments of FIG. 1, a stopper device may be configured, such that a LED substrate, comprising a light source, may be attached to the stopper device, rather than to the housing.

A stopper device 371u according to FIGS. 8A-D may differ from the stopper device 71u of FIG. 1 because the stopper device 371u may not comprise a projection 71p and an urging member 71s2, and a LED substrate 381x may be attached to the opposite side of a bottom of a holder 71h via a frame 381y. The LED substrate 381x may comprise a single light source 381. The LED substrate 381x may affix to the frame 381y, and the LED substrate 381x may be fixed to the holder 71h by engaging the frame 381y with the hook 71f.

Instead of the recess 1y depicted FIGS. 4B and 4C, the housing 1a according to FIGS. 8A-D may comprise a pair of slits 1s and a light transmission device 1t, which may be made from a transparent plate or other materials and which may be disposed between the slits. The slits 1s and the light transmission device 1t may extend along the sub-scanning direction. The holes 1aA and 1aB depicted in FIGS. 4A-4E may not be formed in the housing 1a according to FIGS. 8A-D.

The frame 381y may face the holder 71h, via the LED substrate 381x, and the upper wall of the housing 1a. The light source 381 may be disposed to face the light transmission device 1t. Light emitted by the light source 381 may transmit through the light transmission device 1t, and the stopper 71 may illuminate.

The stopper device 371u may be slidable along the slit 1s in the sub-scanning direction when the hook 71f is inserted in the slit 1s. Therefore, the stopper device 371u may be disposed in the position A and in the position B. In this configuration, the light source 381 may move with the stopper 71 because the light source 381 may be fixed to the stopper 71.

According to FIGS. 8A-D, the light emitted by the light source 381 may illuminate the stopper 71 when the stopper 71 is in either one of the position A and the position B, without using the cover 90, according to the embodiments of FIG. 1, or without using the sensors 7SA and 7SB to activate the light control device 104, according to embodiments of FIG. 6.

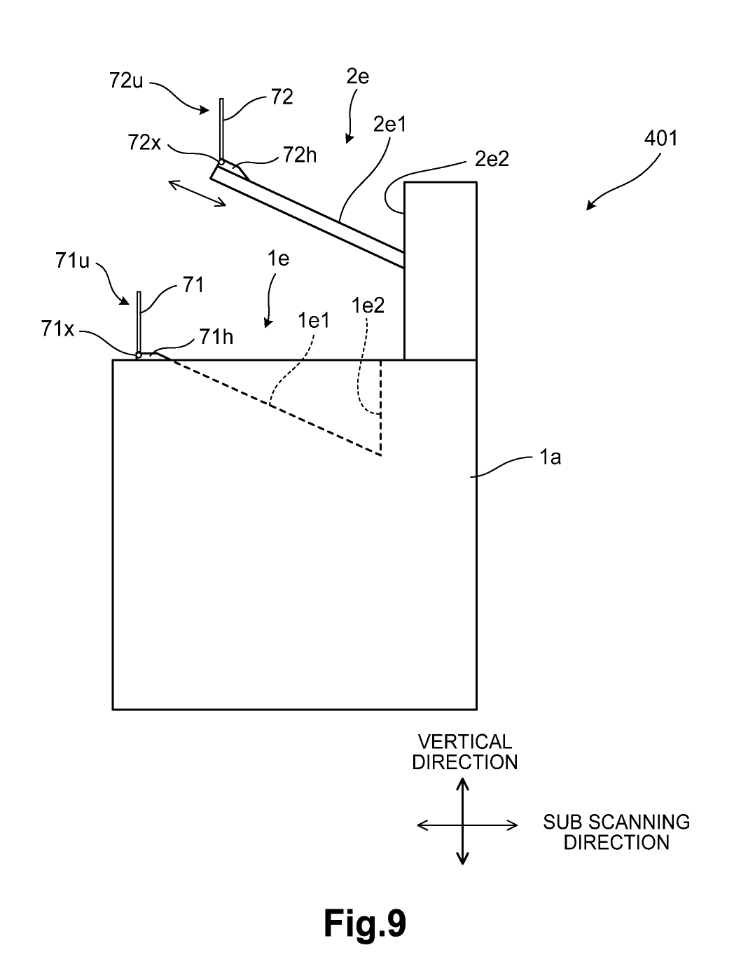

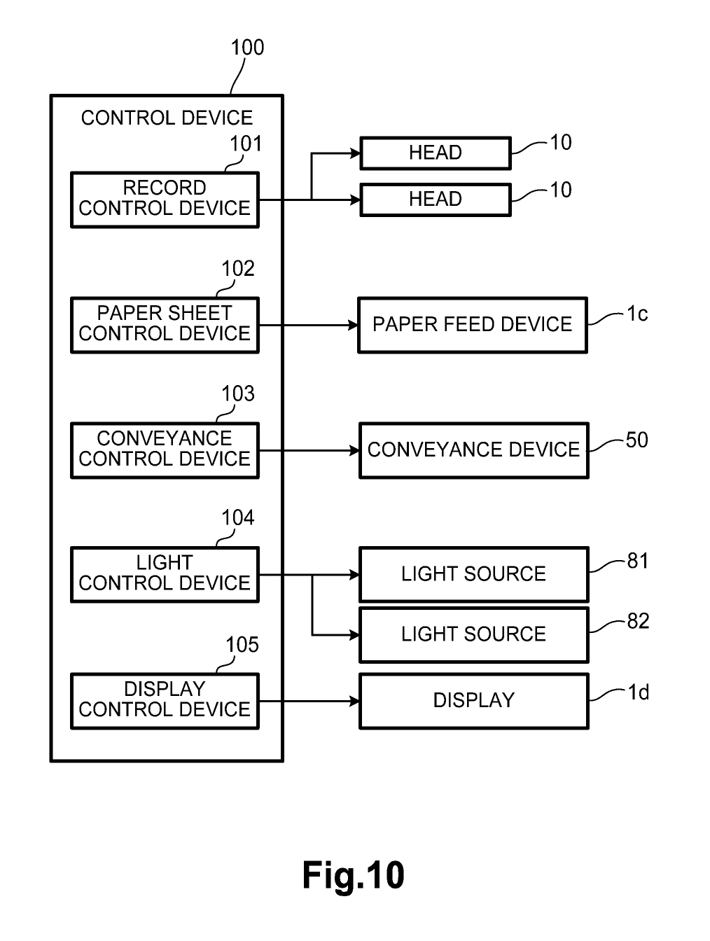

An inkjet printer 401 according to other embodiments of the invention now is described with reference to FIGS. 9 and 10.

The inkjet printer 401 according to FIGS. 9 and 10 may have substantially the same configuration as that of the inkjet printer 1 according to the first embodiment, except for an additional holding portion 2e, which may be attached removably. The additional holding portion 2e may affix to a back surface of an upper portion of the housing 1a, as depicted in FIG. 9. The additional holding portion 2e may comprise substantially the same components as the holding portion 1e, such as a support member 2e1, which may be substantially the same as the support member 1e1; a guide member 2e2, which may be substantially the same as the guide member 1e2; and a stopper device 72u, which may be substantially the same as the stopper device 71u.

The stopper device 72u may comprise a plate-shaped stopper 72, which may be substantially the same as the stopper 71 and a holder 72h that may support rotatably the stopper 72 via a shaft 72x of the stopper 72. The holder 72h may be slidable against an extending portion (the extending portion may be covered by the holder 72h and is not depicted in FIG. 9 for this reason), which may extend from a downstream end of the support member 2e1 in the output direction. The stopper device 72u may not be removable, but instead, may be slidable in the output direction. The stopper device 72u may be disposed at a position for DIN-A4 size recording media, as depicted in FIG. 9. The holder 72h may be drawn (e.g., slid) along the path indicated by the double-headed arrow in FIG. 9 toward the left side of FIG. 9 to change from the position for DIN-A4 size recording media to a position for legal size recording media.

As depicted in the block diagram of FIG. 10, a light source 82, may illuminate the stopper 72 and may be disposed near the shaft 72x in the holder 72h. The light source 82 may affix to the stopper device 72u and may be slidable with the stopper device 72u.

According to FIGS. 9 and 10, a conveyance control device 103 may control a conveying motor of a conveyance device 50 to convey a paper sheet P along a conveying path determined by a selection or by other means. The selected conveying path may be one of a path extending from the paper feed device 1c to the holding portion 1e and a path extending from the paper feed device 1c to the additional holding portion 2e.

The light control device 104 may control the light sources 81 and 82, such that one of the stopper 71 and the stopper 72 may illuminate. The light control device 104 may select one of the light sources 81 and 82 to illuminate based on the holding portion corresponding to the selected conveying path. In particular, when the paper sheet P is output to the holding portion 1e, the light control device 104 may control the light sources 81A and 81B of the light source 81 to emit light, which may illuminate the stopper 71. When the paper sheet P is output to the additional holding portion 2e, the light control device 104 may control the light source 82 to emit light which may illuminate the stopper 72.

The embodiments according to FIGS. 9 and 10 may facilitate determining whether the paper sheet P is output to the holding portion 1e or to the holding portion 2e.

Although embodiments of the invention have been described above, the invention is not limited to these embodiments. Various design changes may be made without departing from the scope described in claims. In modifications, features of embodiments described above may be combined, replaced, improved, and eliminated.

The stopper may be made of various materials other than resin. The stopper may be formed in various shapes, such as a truncated cone shape, instead of the plate shape. The stopper may be rigid, rather than flexible. The stopper may not be transparent, as long as the light emitted by the light source may illuminate the stopper. The surface of the stopper may not be textured (e.g., grained). The stopper may not be disposed at the front of the recording apparatus, but instead, may be disposed at the side or the back of the recording apparatus. The stopper may be removable from the housing of the recording apparatus in the manner of the stopper 71. Alternatively, the stopper may be slidable against the housing of the recording apparatus in the manner of the stopper 72. The stopper may be disposed at two contact positions (e.g., the position A for DIN-A4 size and the position B for legal size as in the embodiment described above), but the stopper also may be disposed at three or more contact positions. Alternatively, the stopper may be disposed at a single contact position.

The sensor, which outputs a signal relative to the position of the stopper, is not limited to the flat spring sensors 7SA and 7SB, but instead, may be one or more of various types of sensors (e.g., a noncontact optical sensor, a magnetic sensor, and an ultrasonic sensor). The sensors may not be disposed at all of the contact positions. In some modifications, for example, the sensors may be disposed at some of the positions corresponding to a portion (e.g., the sensors may be disposed at one position) of the contact positions.

The cover may not be slidable, but instead, may be, for example, removable from the housing of the recording apparatus. The cover may be excluded in a configuration in which the light source may be controlled in accordance with a signal of a sensor, which may output the signal based on the position of the stopper.

The light source may not be a LED, but instead, may be a halogen lamp, a metal halide lamp, a high pressure mercury lamp, or another type of lamp. At least one light source may be adequate. In particular, when the stopper may be disposed in a plurality of contact positions, the light source is not limited to dispositions facing multiple contact positions, but instead, the light source may be disposed to face at least one of the contact positions. For example, a light source may be disposed to face the position A for DIN-A4 size recording media, or a light source may be disposed to face the position B for legal size recording media.

The “emission mode” of the light source may be defined by one or more of color of light, luminous intensity, speed or interval of blinking, and whether the light source is in an “ON” state or an “OFF” state. The “status of the recording apparatus” may comprise a normal status and an error status, as described in foregoing embodiments; a recording status (e.g., when the recording device currently is recording an image on the recording medium); a maintenance status (e.g., when the recording device, the conveyance device, or other components currently are under maintenance); and a recording standby status (e.g., when the recording apparatus is waiting for recording instructions). The “status of the recording apparatus” is not limited to the status of the recording apparatus itself (e.g., the normal status and the error status), but instead, may be the status of each section related to the recording apparatus (e.g., the status of conveyance of the recording medium by the conveyance device). In an example, the emission mode of the light source may change in accordance with an orientation of the recording surface and the order of recording on the recording media.

The recording apparatus may comprise one or more holding portions. When the recording apparatus comprises a plurality of holding portions, each holding portion may have a configuration which may be substantially the same as or different from those of other holding portions. The holding portion may be fixed to the recording apparatus, similar to the holding portion 1e, or may be removable from the recording apparatus, similar to the additional holding portion 2e. The holding portion is not limited to be disposed on the upper surface of the upper wall of the housing of the recording apparatus, but instead, may be disposed at the side of the housing or at other positions. The support surface may extend in one or more of a variety of directions, such as the horizontal direction.

The upper end of the stopper in the standing position may be at a position lower than or the same as a position of the display. The image on the display and the emission of light from the light source may not be in cooperation with each other. Alternatively, the display may be excluded.

The path or paths related to re-conveyance may be excluded. The pressure roller may be excluded. The recording medium may be conveyed in a belt conveyance system, instead of the roller conveyance system of foregoing embodiments. The configuration of the conveying path may be changed. In the foregoing embodiments, the paths R1, R2, and R3 associated with the normal conveyance may form an inverted S shape when combined; however, paths related to the normal conveyance may be other shapes, such as a U shape when combined.

In foregoing embodiments, a recording apparatus may be an inkjet printer comprising two recording devices, such as two heads 10, which are each configured to eject one of black ink and pretreatment liquid. In certain modified configurations, the recording apparatus may comprise more than two recording devices. In some modified configurations, one or more of the recording devices may eject color ink. In other modified configurations, one or more of the recording devices may eject liquid other than pretreatment liquid and ink. The recording apparatus may not be limited to a liquid ejection recording apparatus, such as the inkjet printer described in foregoing embodiments. In particular modified configurations, the recording apparatus may be a laser printer comprising a laser recording device and a heat transfer recording device. In the laser recording device, a laser beam or other means may irradiate a charged photoconductor to form an electrostatic image on the photoconductor. The electrostatic image may be transferred to a recording medium. In the heat transfer recording device, ink applied to a tape may be transferred to the recording medium by the application of heat.

The recording medium is not limited to the paper sheet P, but instead, may be one or more of a variety of media adapted to recording. The housing of the recording apparatus may comprise a first housing and a second housing, which may be movable (e.g., rotatable) with respect to the first housing. The invention is not limited to a printer, but instead, may be applied to other apparatus, such as facsimile machines and copiers.

While the invention has been described in connection with various exemplary structures and illustrative embodiments, it will be understood by those skilled in the art that other variations and modifications of the structures, configurations, and embodiments described above may be made without departing from the scope of the invention. For example, this application comprises any possible combination of the various elements and features disclosed herein, and the particular elements and features presented in the claims and disclosed above may be combined with each other in other ways within the scope of the application, such that the application should be recognized as also directed to other embodiments comprising any other possible combinations. Other structures, configurations, and embodiments consistent with the scope of the claimed invention will be apparent to those skilled in the art from a consideration of the specification or practice of the invention disclosed herein. It is intended that the specification and the described examples are illustrative with the true scope of the invention being defined by the following claims.

What is claimed is:

1. A recording apparatus comprising:
a recorder configured to record an image on a recording medium at a recording position;
a conveyer configured to convey a recording medium through the recording position and to output the recording medium along an output direction;
a holder configured to hold a recording medium output by the conveyer;
a stopper disposed downstream of the holder along the output direction,
wherein the stopper is configured to contact an end of a recording medium when the recording medium is output by the conveyer and the stopper is in a first position, and
wherein the stopper is configured to move selectively between the first position and a second position, in which an end of the stopper is farther to the holder than when in the first position; and
an urging member configured to urge the stopper to move to the first position from the second position.

2. The recording apparatus according to claim 1, wherein the conveyer is configured to output the recording medium at a speed, such that the recording medium passes over the holder, when the stopper is not disposed in the first position.

3. The recording apparatus according to claim 1, further comprising a base disposed upstream from the stopper along a vertical direction,
wherein the base is configured to support the recording apparatus while the recorder records an image on a recording medium, and
wherein the end of the stopper is disposed further downstream along the vertical direction than the holder.

4. The recording apparatus according to claim 1, further comprising a base disposed upstream from the stopper along a vertical direction,
wherein the base is configured to support the recording apparatus while the recorder records an image on a recording medium, and
wherein the stopper comprises a plate and the plate extends in substantially the vertical direction when the stopper is in the first position.

5. The recording apparatus according to claim 4, wherein the output direction is substantially perpendicular to the vertical direction.

6. The recording apparatus according to claim 4, wherein the plate extends in substantially a horizontal direction when the stopper is in the second position.

7. The recording apparatus according to claim 1, wherein the urging member is a spring.

8. The recording apparatus according to claim 1, wherein the stopper is configured to move selectively between the first position and the second position by rotating about an axis of rotation.

9. The recording apparatus according to claim 1,
wherein the stopper is configured to return to the first position unless a force external to the recording apparatus acts on the stopper, and
wherein the force external to the recording apparatus is greater than an urging force generated by the urging member.

10. The recording apparatus according to claim 1, further comprising:
a light source configured to illuminate the stopper; and
a light controller configured to control the light source.

11. A recording apparatus comprising:
a recorder configured to record an image on a recording medium at a recording position;
a conveyer configured to convey the recording medium through the recording position and to output the recording medium along an output direction;
a holder configured to hold a recording medium output by the conveyer;
a stopper disposed downstream of the holder in the output direction,
wherein the stopper is configured to contact an end of a recording medium when the recording medium is output by the conveyer and the stopper is in a first position;
a light source configured to illuminate the stopper; and
a light controller configured to control the light source.

12. The recording apparatus according to claim 11,
wherein the stopper is configured to be disposed at one of a plurality of contact positions along the output direction,
wherein each contact position of the plurality of contact positions corresponds to one of a plurality of sizes of recording media.

13. The recording apparatus according to claim 12,
wherein the plurality of contact positions comprises a particular contact position, and
wherein the light source comprises a particular separate light source disposed to face the particular contact position.

14. The recording apparatus according to claim 13, further comprising a cover configured to cover the particular separate light source when the stopper is disposed at another contact position of the plurality of contact positions that is different from the particular contact position.

15. The recording apparatus according to claim 14,
wherein the light source comprises a plurality of separate light sources,
wherein each separate light source of the plurality of separate light sources is disposed to face a respective one of the plurality of contact positions,
wherein the plurality of separate light sources comprises the particular separate light source, and
wherein the cover is configured to slide along the output direction, such that the cover covers each separate light source of plurality of separate light sources that faces a contact position of the plurality of contact positions that is different from the particular contact position when the stopper is disposed at the particular contact position.

16. The recording apparatus according to claim 12,
wherein the light source comprises a plurality of separate light sources, and
wherein each separate light source of the plurality of separate light sources is disposed to face a respective one of the plurality of contact positions.

17. The recording apparatus according to claim 16, further comprising a cover configured to cover separate light sources of the plurality separate light sources that face contact positions of the plurality of contact positions that are different from the one of the plurality of contact positions at which the stopper is disposed.

18. The recording apparatus according to claim 17, wherein the cover is configured to slide in the output direction and in a direction opposite to the output direction.

19. The recording apparatus according to claim 16, further comprising a sensor configured to output a signal relative to a position of the stopper among the plurality of contact positions,
wherein the light controller is configured to control the light source,
such that a separate light source of the plurality of separate light sources that corresponds to the one of the plurality of contact positions at which the stopper is disposed emits light in accordance with the signal output by the sensor, and
such that other separate light sources of the plurality of separate light sources that correspond to contact positions of the plurality of contact positions that are different from the one of the plurality of contact positions at which the stopper is disposed do not emit light in accordance with the signal output by the sensor.

20. The recording apparatus according to claim 12, wherein the light source is fixed to the stopper and is configured to move with the stopper.

21. The recording apparatus according to claim 11 comprising:
a plurality of holders comprising the holder, wherein each holder of the plurality of holders is configured to hold a recording medium output by the conveyer;
a plurality of stoppers comprising the stopper, wherein each stopper of the plurality of stoppers corresponds to a respective one of the plurality of holders; and
a plurality of light sources comprising the light source, wherein each light source of the plurality of light sources corresponds to a respective one of the plurality of stoppers,
wherein the light controller is configured to control the plurality of light sources, such that a light source that corresponds to a stopper that corresponds to a holder that receives the recording medium therein lights up the stopper.

22. The recording apparatus according to claim 11, further comprising:
a housing configured to store the recorder and the conveyer therein; and
a base disposed upstream from the stopper along a vertical direction,
wherein the holder is disposed at a surface of a wall of the housing,
wherein the wall of the housing is a farthest downstream wall of the housing along the vertical direction, and
wherein the surface is a downstream surface of the wall of the housing.

23. The recording apparatus according to claim 11, further comprising:
a display configured to display a status of the recording apparatus thereon;
a display controller configured to control the display to display in a display mode selected from a plurality of display modes based on the state of the recording apparatus; and
a base disposed upstream from the stopper along a vertical direction,
wherein the base is configured to support the recording apparatus while the recorder records an image on a recording medium, and
wherein an end of the stopper is disposed further downstream along the vertical direction than the display.

24. The recording apparatus according to claim 23, wherein the light controller is configured to cooperate with the display controller and to control the light source to emit light in cooperation with the display.

25. The recording apparatus according to claim 11, further comprising a base disposed upstream from the stopper along a vertical direction,
wherein the base is configured to support the recording apparatus while the recorder records an image on a recording medium, and
wherein an end of the stopper is disposed further downstream along the vertical direction than the holder.

26. The recording apparatus according to claim 25, wherein the end of the stopper is disposed farther downstream along the vertical direction than all other portions of the recording apparatus.

27. The recording apparatus according to claim 11, wherein the conveyer is configured to output the recording medium at a speed, such that the recording medium would pass over the holder in a configuration in which the stopper is not disposed downstream of the holder in the output direction.

28. The recording apparatus according to claim 27, wherein the stopper is configured to move selectively between the first position and a second position, in which an end of the stopper is farther to the holder than when in the first position, and
wherein the recording apparatus further comprises an urging member configured to urge the stopper to move to the first position from the second position.

29. The recording apparatus according to claim 11, wherein the light controller is configured to control the light source to emit light in an emission mode selected from a plurality of emission modes based on a status of the recording apparatus.

30. The recording apparatus according to claim 29, wherein the light controller is configured to control the light source to emit light in a predetermined emission mode when the recording apparatus is in an error status.
